(19) United States
(12) Patent Application Publication
(10) Pub. No.: US 2023/0215196 A1
(43) Pub. Date: Jul. 6, 2023

(54) INFORMATION PROCESSING APPARATUS, INFORMATION PROCESSING METHOD, AND PROGRAM

(71) Applicant: Sony Semiconductor Solutions Corporation, Kanagawa (JP)

(72) Inventor: Tatsuya Sakashita, Kanagawa (JP)

(73) Assignee: Sony Semiconductor Solutions Corporation, Kanagawa (JP)

(21) Appl. No.: 17/912,648

(22) PCT Filed: Mar. 11, 2021
(86) PCT No.: PCT/JP2021/009788

§ 371 Date: Sep. 19, 2022

(30) Foreign Application Priority Data
Mar. 26, 2020 (JP) 2020-056038

(51) Int. Cl. G06V 20/70; G06T 7/50; G06V 10/774; G06V 10/94

(52) U.S. Cl. CPC G06V 20/70; G06T 7/50; G06V 10/774; G06V 10/945; G06T 2200/24; G06V 2201/08; G06T 2207/20081; G06T 2207/30252; G06T 2207/20084

(57) ABSTRACT

An information processing apparatus according to an embodiment of the present technology includes a generation unit. The generation unit generates, with respect to a target object in an image for learning on the basis of input information regarding an outer shape of the target object, which is input from a user, a three-dimensional region surrounding the target object as a label. Accordingly, the annotation accuracy can be improved.

### TECHNICAL FIELD

The present technology relates to an information processing apparatus, an information processing method, and a program that can be applied to annotation.

### BACKGROUND ART

Patent Literature 1 has disclosed an annotation technology aiming at correctly applying desired information to sensor data.

### CITATION LIST

### Patent Literature

Patent Literature 1: Japanese Patent Application Laid-open No. 2019-159819

### DISCLOSURE OF INVENTION

### Technical Problem

For example, a case of generating training data for machine learning, the annotation accuracy is important.

In view of the above-mentioned circumstances, it is an objective of the present technology to provide an information processing apparatus, an information processing method, and a program that are capable of improving the annotation accuracy for a target object.

### Solution to Problem

In order to accomplish the above-mentioned objective, an information processing apparatus according to an embodiment of the present technology includes a generation unit.

The generation unit generates, with respect to a target object in an image on the basis of information regarding an outer shape of the target object, a three-dimensional region surrounding the target object as a label.

Moreover, the information regarding the outer shape is a part of the label.

Moreover, the generation unit interpolates, on the basis of a part of the label, another part of the label to thereby generate the label.

In this information processing apparatus, on the basis of the information regarding the outer shape of the target object, the three dimensional region that is the target object is generated as the label. In the present embodiment, the part of the label is used as the information regarding the outer shape of the target object and the other part of the label is interpolated to thereby generate the label. Accordingly, the annotation accuracy can be improved.

The image may be an image for learning. In this case, the generation unit may generate the label on the basis of the information regarding the outer shape, which is input from the user.

The information processing apparatus may further include a GUI output unit that outputs a graphical user interface (GUI) for inputting the information regarding the outer shape of the target object with respect to the image for learning.

The label may be a three-dimensional bounding box.

The label may be a three-dimensional bounding box. In this case, the information regarding the outer shape may include a first rectangular region positioned on a front side of the target object and a position of a second rectangular region that is opposite to the first rectangular region and positioned on a deep side of the target object. Moreover, the generation unit may interpolate, on the basis of the first rectangular the region and the position of the second rectangular region, the second rectangular region to thereby generate the three-dimensional bounding box.

The position of the second rectangular region may be a position of a vertex of the second rectangular region, which is connected to a vertex positioned at a lowermost position of the first rectangular region.

The position of the second rectangular region may be a position on a deepest side of the target object on a line extending to a deep side on a surface on which the target object is disposed from a vertex positioned at a lowermost position of the first rectangular region.

The target object may be a vehicle. In this case, the position of the second rectangular region may be a position on a deepest side of the target object on a line that extends from a vertex positioned at a lowermost position of the first rectangular region and is parallel to a line connecting grounding points of a plurality of wheels arranged in a direction in which the first rectangular region and the second rectangular region are opposite to each other.

The vertex positioned at the lowermost position of the first rectangular region may be positioned on the line connecting the grounding points of the plurality of wheels arranged in the direction in which the first rectangular region and the second rectangular region are opposite to each other.

The generation unit may generate the label on the basis of vehicle type information regarding the vehicle.

The image for learning may be an image captured by an imaging device. In this case, the generation unit may generate the label on the basis of imaging information regarding imaging of the image for learning.

The generation unit may generate the label on the basis of information about a vanishing point in the image for learning.

The target object may be a vehicle.

The image for learning may be a two-dimensional image.

An information processing method according to an embodiment of the present technology is an information processing method to be executed by a computer system, including a generation step includes.

The generation step of generating, with respect to a target object in an image on the basis of information regarding an outer shape of the target object, a three-dimensional region surrounding the target object as a label.

Moreover, the information regarding the outer shape is a part of the label.

Moreover, the generation step is interpolating, on the basis of a part of the label, another part of the label to thereby generate the label.

A program according to an embodiment of the present technology causes a computer system to execute the above-mentioned information processing method.

### BRIEF DESCRIPTION OF DRAWINGS

FIG. 1 A schematic diagram for describing a configuration example of an annotation system according to an embodiment.

FIG. 2 A schematic diagram showing a functional configuration example of an information processing apparatus.

FIG. 3 A schematic diagram for describing a generation example of a machine learning model.

FIG. 4 A schematic diagram showing an example of a GUI for annotation.

FIG. 5 A schematic diagram showing an operation example of automatic annotation by interpolation.

FIG. 6 A flowchart showing an example of the automatic annotation by interpolation.

FIG. 7 A schematic diagram showing the annotation example of the label.

FIG. 8 A schematic diagram showing the annotation example of the label.

FIG. 9 A schematic diagram showing the annotation example of the label.

FIG. 10 A schematic diagram showing the annotation example of the label.

FIG. 11 A schematic diagram for describing an example of a calculation method for a distance to a lowermost vertex of a front surface rectangle and a distance for the corresponding vertex of a rear surface rectangle.

FIG. 12 A block diagram showing a configuration example of the vehicle control system.

FIG. 13 A block diagram showing a hardware configuration example of an information processing apparatus.

### MODE(S) FOR CARRYING OUT THE INVENTION

Hereinafter, embodiments according to the present technology will be described with reference to the drawings.

[Annotation System]

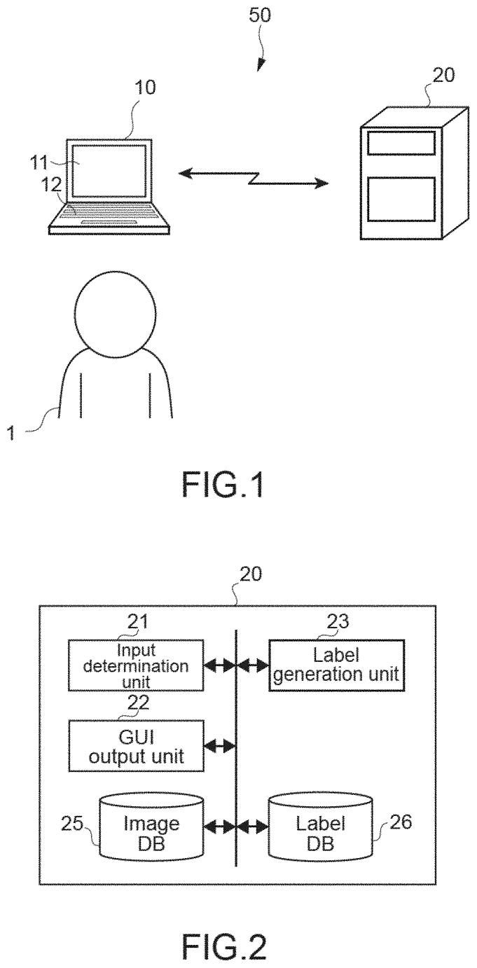

FIG. 1 is a schematic diagram for describing a configuration example of an annotation system according to an embodiment of the present technology.

An annotation system 50 includes a user terminal 10 and an information processing apparatus 20.

The user terminal 10 and the information processing apparatus 20 are connected to communicate with each other via a wire or wirelessly. The connection form between the respective devices is not limited and, for example, wireless LAN communication such as Wi-Fi or near-field communication such as Bluetooth (registered trademark) can be utilized.

The user terminal 10 is a terminal that a user 1 operates.

The user terminal 10 includes a display unit 11 and an operation unit 12.

The display unit 11 is, for example, a display device using liquid-crystal, electro-luminescence (EL), or the like.

The operation unit 12 is, for example, a keyboard, a pointing device, a touch panel, or another operation device. In a case where the operation unit 12 includes a touch panel, the touch panel can be integral with the display unit 11.

As the user terminal 10, for example, any computer such as a personal computer (PC) may be used.

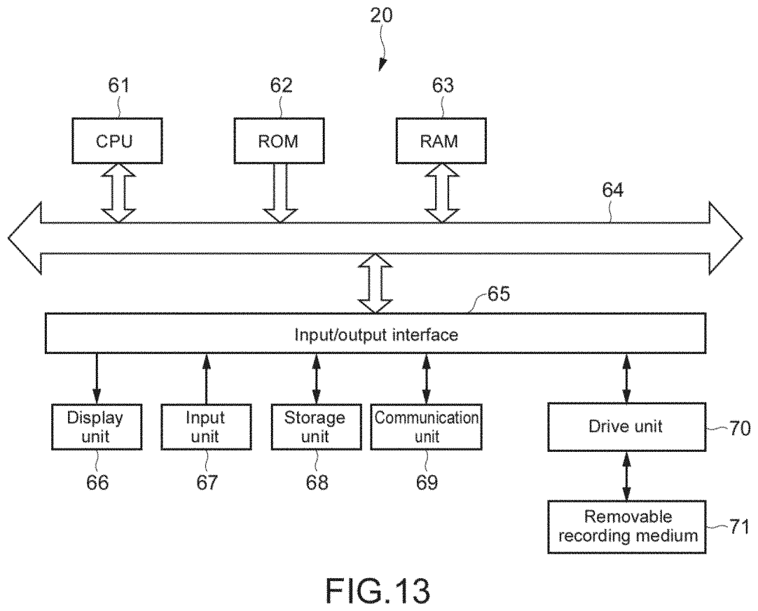

The information processing apparatus 20 includes hardware required for configurations of a computer including, for example, processors such as a CPU, a GPU, and a DSP, memories such as a ROM and a RAM, a storage device such as an HDD (see FIG. 13).

For example, the CPU loads a program according to the present technology recorded in the ROM or the like in advance to the RAM and executes the program to thereby execute an information processing method according to the present technology.

For example, any computer such as a personal computer (PC) can realize the information processing apparatus 20. As a matter of course, hardware such as FPGA and ASIC may be used.

The program is, for example, installed in the information processing apparatus 20 via various recording media. Alternatively, the program may be installed via the Internet or the like.

The kind of recording medium and the like in which the program is recorded are not limited, and any computer-readable recording medium may be used. For example, any computer-readable non-transitory storage medium may be used.

FIG. 2 is a schematic diagram showing a functional configuration example of the information processing apparatus 20.

In the present embodiment, a CPU or the like executes a predetermined program, and an input determination unit 21, a GUI output unit 22, and a label generation unit 23 as functional blocks are thus configured. As a matter of course, in order to realize the functional blocks, dedicated hardware such as an integrated circuit (IC) may be used.

Moreover, in the present embodiment, an image database (DB) 25 and a label DB 26 are built in a storage unit (e.g., a storage unit 68 shown in FIG. 13) of the information processing apparatus 20.

The image DB 25 and the label DB 26 may be constituted by an external storage device and the like connected to communicate with the information processing apparatus 20. In this case, the information processing apparatus 20 with the external storage device can be considered as an embodiment of an information processing apparatus according to of the present technology.

The GUI output unit 22 generates and outputs a GUI for annotation. The output GUI for annotation is displayed on the display unit 11 of the user terminal 10.

The input determination unit 21 determines information that the user 1 inputs through the operation unit 12 (hereinafter, referred to as input information). The input determination unit 21 determines what instruction or information has been input on the basis of, for example, a signal (operation signal) according to the operation of the operation unit 12 by the user 1.

In the present disclosure, the input information includes both a signal input in accordance with an operation of the operation unit 12 and information determined on the basis of the input signal.

In the present embodiment, the input determination unit 21 determines various kinds of input information input via the GUI for annotation.

The label generation unit 23 generates a label (training label) associated with an image for learning.

The image DB 25 stores images for learning.

The label DB 26 stores labels associated with the images for learning.

By setting a label with respect to an image for learning, training data for learning a machine learning model is generated.

In the present embodiment, a case where machine learning-based recognition processing is performed with respect to an image captured by the imaging device will be taken as an example.

Specifically, a case where a machine learning model that outputs a recognition result of another vehicle is built using as an image captured by a vehicle-mounted camera installed in a vehicle as the input will be taken as an example. Therefore, in the present embodiment, the vehicle corresponds to a target object.

The image DB 25 stores images captured by the vehicle-mounted camera as images for learning. In the present embodiment, it is assumed that the images for learning are two-dimensional images. As a matter of course, the present technology can be applied also in a case where three-dimensional images are captured.

For example, a digital camera including an image sensor such as a complementary metal-oxide semiconductor (CMOS) sensor and a charge coupled device (CCD) sensor is used as the vehicle-mounted camera. Otherwise, any camera may be used.

In the present embodiment, a three-dimensional bounding box (BBox) is output as a three-dimensional region surrounding the vehicle as a recognition result of the vehicle.

The three-dimensional BBox is a three-dimensional region surrounded by six rectangular regions (surfaces), such as a cubic shape and a rectangular parallelepiped shape. For example, the three-dimensional BBox is defined by coordinates of pixels that are eight vertices in an image for learning.

For example, two rectangular regions (surfaces) opposite to each other are defined. Then, the three-dimensional BBox can be defined by coupling vertices of the respective surfaces, which are opposite to each other. As a matter of course, information, a method and the like for defining the three-dimensional BBox are not limited.

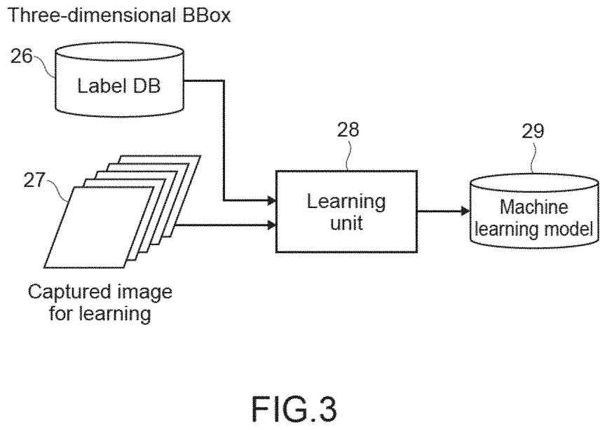

FIG. 3 is a schematic diagram for describing a generation example of a machine learning model.

An image for learning 27 and a label (three-dimensional BBox) are associated with each other and input in a learning unit 28 as training data.

The learning unit 28 uses the training data and performs learning on the basis of a machine learning algorithm. With the learning, parameters (coefficients) for calculating the three-dimensional BBox are updated and generated as learned parameters. A program in which the generated learned parameters are incorporated is generated as a machine learning model 29.

In response to the input of the image of the vehicle-mounted camera, the three-dimensional BBox is output by the machine learning model 29.

For example, neural network and deep learning are used for learning techniques in the learning unit 28. The neural network is a model that mimics neural networks of a human brain. The neural network is constituted by three types of layers of an input layer, an intermediate layer (hidden layer), and an output layer.

The deep learning is a model using neural networks with a multi-layer structure. The deep learning can repeat characteristic learning in each layer and learn complicated patterns hidden in mass data.

The deep learning is, for example, used for the purpose of identifying objects in an image or words in a speech. For example, a convolutional neural network (CNN) or the like used for recognition of an image or moving image is used.

Moreover, a neuro chip/neuromorphic chip in which the concept of the neural network has been incorporated can be used as a hardware structure that realizes such machine learning.

Otherwise, any machine learning algorithm may be used.

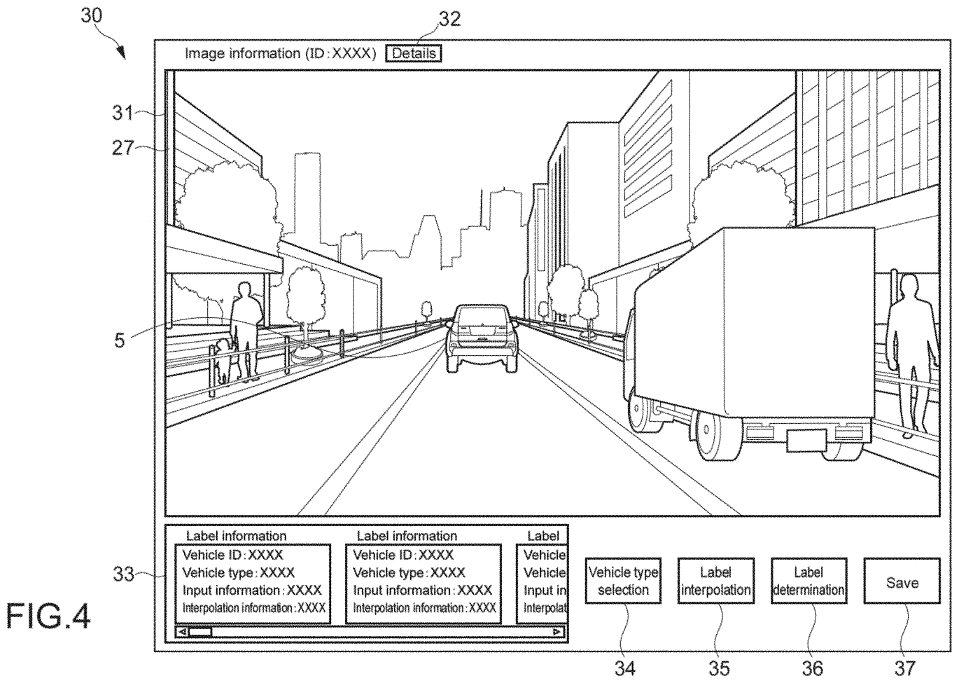

FIG. 4 is a schematic diagram showing an example of the GUI for annotation.

The user 1 can generate a three-dimensional BBox with respect to a vehicle 5 in the image for learning 27 via a GUI for annotation 30 displayed on the display.

The GUI for annotation 30 includes an image display portion 31, an image information display button 32, an label information display portion 33, a vehicle type selection button 34, a label interpolation button 35, a label determination button 36, and a save button 37.

When the image information display button 32 is selected, information regarding the image for learning 27 is displayed. For example, any information of the image for learning 27, an imaging location, imaging date and time, weather, and various parameters related to imaging (e.g., angle of view, zoom, shutter speed, f-number), may be displayed.

Information regarding the three-dimensional BBox that is a label annotated by the user 1 is displayed on the label information display portion 33.

For example, in the present embodiment, the following information is displayed.

Vehicle ID: information that identifies the vehicle selected by the user 1

Vehicle type: information or the like in a case where vehicles such as a “small-sized vehicle”, a “large-sized vehicle”, a “van”, a “truck”, and a “bus” for example are classified by model displayed as vehicle type information. As a matter of course, more detailed type information may be displayed as the vehicle type information.

Input information: information input by the user 1 (front surface rectangle and rear end position)

Interpolation information: information (rear surface rectangle) interpolated by the information processing apparatus 20

It should be noted that the front surface rectangle, the rear end position, and the rear surface rectangle will be described later.

The vehicle type selection button 34 is used for selecting/changing the vehicle type.

The label interpolation button 35 is used for performing label interpolation by the information processing apparatus 20.

The label determination button 36 is used for completing generation of the label (three-dimensional BBox).

The save button 37 is used for saving the generated label (three-dimensional BBox) when the annotation is completed with respect to the image for learning 27.

As a matter of course, a configuration and the like of the GUI for annotation 30 are not limited, and may be arbitrarily designed.

[Automatic Annotation by Interpolation]

In the present embodiment, the information processing apparatus 20 performs automatic annotation by interpolation.

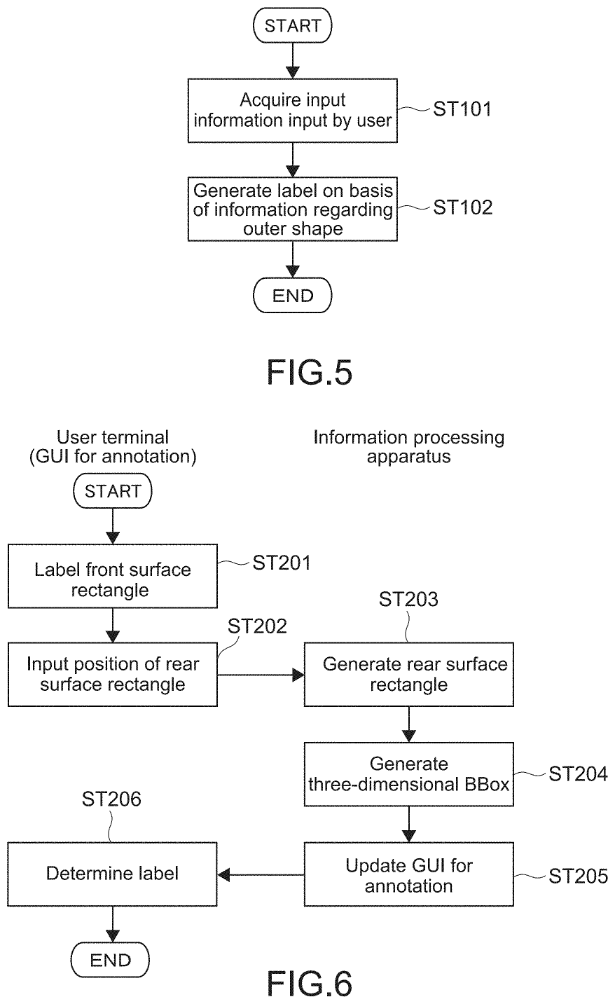

FIG. 5 is a schematic diagram showing an operation example of the automatic annotation by interpolation.

The input determination unit 21 acquires input information regarding an outer shape of the vehicle 5 (target object) (Step 101), which is input from the user 1 with respect to the vehicle 5 (target object) in the image for learning 27.

The input information regarding the outer shape of the vehicle 5 includes any information regarding the outer shape of the vehicle 5. For example, information regarding respective parts of the vehicle 5, such as wheels, an A-pillar, a windshield, a light, and side-view mirrors, may be input as the input information.

Moreover, information or the like regarding sizes that are a height of the vehicle 5, a length (size in front-rear direction), and a width (size in horizontal direction) may be input as the input information.

Moreover, information about a three-dimensional region surrounding the vehicle 5, for example, a part of three-dimensional BBOX may be input as the input information.

The label generation unit 23 generates a label on the basis of the input information input from the user 1 (Step 102).

For example, the user 1 inputs a part of a label wished to be added to the image for learning 27 as the input information. The label generation unit 23 interpolates another part of the label on the basis of the input part of the label, to thereby generate the label.

The present technology is not limited thereto, and information different from the label may be input as the input information and the label may be generated on the basis of the input information.

FIG. 6 is a flowchart showing an example of the automatic annotation by interpolation.

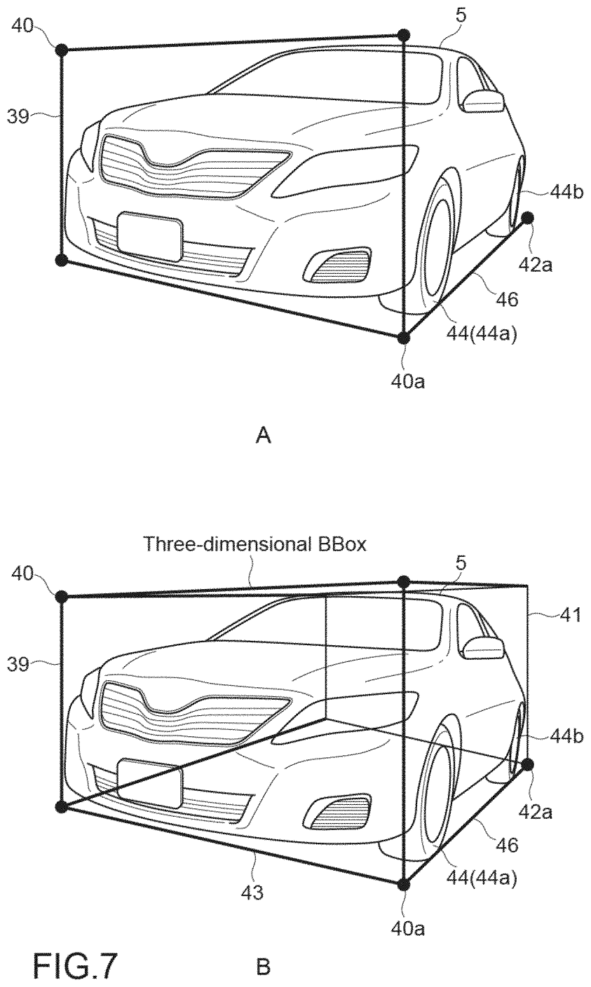

FIGS. 7 to 10 are schematic diagrams showing label annotation examples.

In the present embodiment, with respect to the image for learning 27 displayed in the GUI for annotation 30, the three-dimensional BBox surrounding the vehicle 5 is annotated as the label.

The user 1 labels a front surface rectangle 39 (Step 201).

As shown in each A of FIGS. 7 to 10, the front surface rectangle 39 is a rectangular region of the annotated three-dimensional BBox, which is positioned on a front side of the vehicle 5. That is, a surface close to the vehicle-mounted camera is the front surface rectangle 39.

It can also be said that for the user 1 seeing the image for learning 27, the rectangular region positioned on the front side of the vehicle 5 is a region including four vertices, from which the entire object can be seen. Moreover, two rectangular regions can exist as the rectangular region of the annotated three-dimensional BBox, which is positioned on the front side of the vehicle 5.

For example, the rectangular region positioned on a frontmost side is labelled as the front surface rectangle 39. That is, a rectangular region easiest for the user 1 to see is labelled as the front surface rectangle 39. As a matter of course, the present technology is not limited thereto.

For example, using a device such as a mouse, positions of four vertices 40 of the front surface rectangle 39 are specified. Or, it may be possible to directly input coordinates of pixels that are the four vertices 40.

Alternatively, the rectangular region may be displayed by inputting the width and the height of the front surface rectangle 39 and the user 1 may be able to change the position of the region. Otherwise, any method may be employed as a method of inputting the front surface rectangle 39.

In the present embodiment, the front surface rectangle 39 corresponds to a first rectangular region.

The user 1 inputs a position of a rear surface rectangle 41 (Step 202).

As shown in each B of FIGS. 7 to 10, the rear surface rectangle 41 is a rectangular region that is opposite to the front surface rectangle 39 and positioned on the deep side of the vehicle 5. That is, a surface far from the vehicle-mounted camera is the rear surface rectangle 41. In Step 202, the user 1 inputs a position at which the rear surface rectangle 41 is arranged.

As shown in each A of FIGS. 7 to 10, in the present embodiment, the user 1 inputs, as the position of the rear surface rectangle 41, a position of a vertex 42a of the rear surface rectangle 41 (hereinafter, referred to as corresponding vertex), which is connected to a vertex 40a (hereinafter, referred to as lowermost vertex) positioned at a lowermost position of the front surface rectangle 39.

It should be noted that inputting the lowermost vertex 40a of the front surface rectangle 39 and the position of the corresponding vertex 42a of the rear surface rectangle 41, which is connected thereto, is equivalent to inputting one side of a rectangular region 43 (hereinafter, referred to as grounding rectangle), which is a side (i.e., ground side) on which the vehicle 5 is placed and which is constitutes the three-dimensional BBox.

That is, the user 1 only needs to input the position of the corresponding vertex 42a of the rear surface rectangle 41 while being aware of a segment that is one side of the grounding rectangle 43 from the lowermost vertex 40a of the front surface rectangle 39.

For example, the user 1 inputs a position on a deepest side of the vehicle 5 on a line extending to the deep side on the surface on which the vehicle 5 is disposed from the lowermost vertex 40a of the front surface rectangle 39.

The line extending to the deep side on the surface on which the vehicle 5 is disposed can be grasped as a line parallel to a line connecting grounding points of a plurality of wheels 44 arranged in a direction in which the front surface rectangle 39 and the rear surface rectangle 41 are opposite to each other.

That is, the user 1 inputs the position on the deepest side of the vehicle 5 on a line parallel to a line 46 (hereinafter, referred to as grounding direction line) connecting the grounding points of the plurality of wheels 44 arranged in the direction in which the front surface rectangle 39 and the rear surface rectangle 41 are opposite to each other, the line extending from the lowermost vertex 40a of the front surface rectangle 39. Accordingly, it is possible to input the position of the rear surface rectangle 41.

It is based on the fact that the extending direction of the grounding direction line 46 connecting the grounding points of the plurality of wheels 44 is often parallel to the extending direction of one side of the grounding rectangle 43.

In the present embodiment, the rear surface rectangle 41 corresponds to a second rectangular shape that is opposite to the first rectangular region and positioned on a deep side of the target object.

In the example shown in FIG. 7, the front surface rectangle 39 is labelled on the front side of the vehicle 5.

Then, a position of the corresponding vertex 42a that is a lower right vertex of the rear surface rectangle 41, which is connected to the lowermost vertex 40a that is a lower right vertex of the front surface rectangle 39 as viewed from the user 1, is input as the position of the rear surface rectangle 41.

In the example shown in FIG. 7, the position on the deepest side of the vehicle 5 on the grounding direction line 46 connecting the grounding points of a front left wheel 44a and a rear left wheel 44b of the vehicle 5 and extending from the lowermost vertex 40a of the front surface rectangle 39 is input as the position of the corresponding vertex 42a.

For example, when the user 1 inputs the position of the rear surface rectangle 41 (the position of the corresponding vertex 42a), a guide line connecting the lowermost vertex 40a of the front surface rectangle 39 and the position of the rear surface rectangle 41 to each other is displayed. The user 1 can adjust the position of the lowermost vertex 40a of the front surface rectangle 39 and the position of the rear surface rectangle 41 so that the displayed guide line is parallel to the grounding direction line 46.

Moreover, as shown in FIG. 7A, the user 1 can adjust the position of the lowermost vertex 40a of the front surface rectangle 39 and the position of the rear surface rectangle 41 so that the guide line connecting the lowermost vertex 40a of the front surface rectangle 39 and the position of the rear surface rectangle 41 to each other coincides with the grounding direction line 46.

In this manner, the lowermost vertex 40a of the front surface rectangle 39 and the corresponding vertex 42a of the rear surface rectangle 41 may be input to be positioned on the grounding direction line 46. That is, the grounding direction line 46 may be input as one side constituting the three-dimensional BBox.

The guide line connecting the lowermost vertex 40a of the front surface rectangle 39 and the position of the rear surface rectangle 41 to each other is displayed. It enables the user 1 to adjust the position of each vertex of the front surface rectangle 39 and the position of the rear surface rectangle 41 (the position of the corresponding vertex 42a). Accordingly, a highly accurate three-dimensional BBox can be annotated.

For example, it is assumed that there are two rectangular regions on the front side of the vehicle 5 as viewed from the user 1. In this case, the front surface rectangle 39 is labeled on a surface different from the surface from which the wheels 44 that define the grounding direction line 46 can be seen. Then, the position of the rear surface rectangle 41 is input on the basis of using the displayed guide line and the grounding direction line 46. Such processing is also possible, and it is advantageous for annotation of a highly accurate three-dimensional BBox.

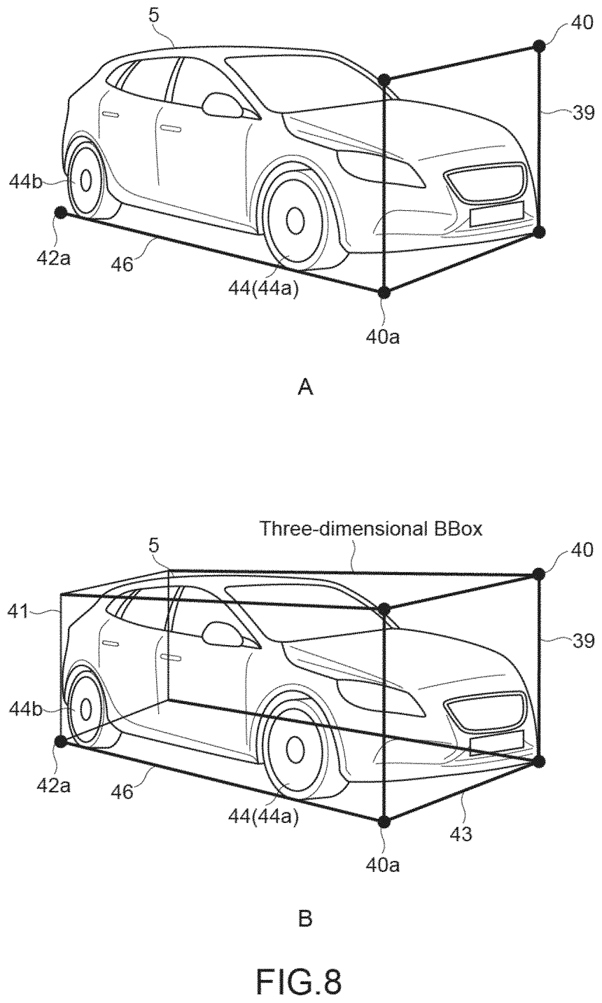

In the example shown in FIG. 8, the front surface rectangle 39 is labelled on the front side of the vehicle 5.

Then, the position of the corresponding vertex 42a that is the lower left vertex of the rear surface rectangle 41, which is connected to the lowermost vertex 40a that is the lower left vertex of the front surface rectangle 39 as viewed from the user 1, is input as the position of the rear surface rectangle 41.

The position of the rear surface rectangle 41 is set on the basis of the grounding direction line 46 connecting the grounding points of a front right wheel 44a and a rear right wheel 44b of the vehicle 5. Specifically, the position of the lowermost vertex 40a of the front surface rectangle 39 and the position of the corresponding vertex 42a of the rear surface rectangle 41 are set on the grounding direction line 46.

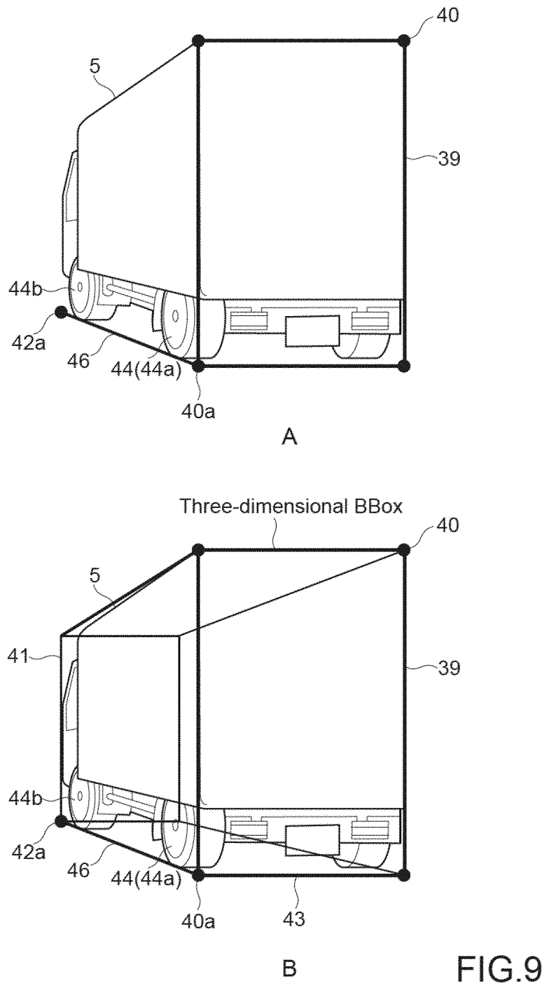

In the example shown in FIG. 9, the front surface rectangle 39 is labelled on the rear side of the vehicle 5.

Then, the position of the corresponding vertex 42a that is the lower left vertex of the rear surface rectangle 41, which is connected to the lowermost vertex 40a that is the lower left vertex of the front surface rectangle 39 as viewed from the user 1, is input as the position of the rear surface rectangle 41.

The position of the rear surface rectangle 41 is set on the basis of the grounding direction line 46 connecting the grounding points of a rear left wheel 44a and a front left wheel 44b of the vehicle 5. Specifically, the position of the lowermost vertex 40a of the front surface rectangle 39 and the position of the corresponding vertex 42a of the rear surface rectangle 41 are set on the grounding direction line 46.

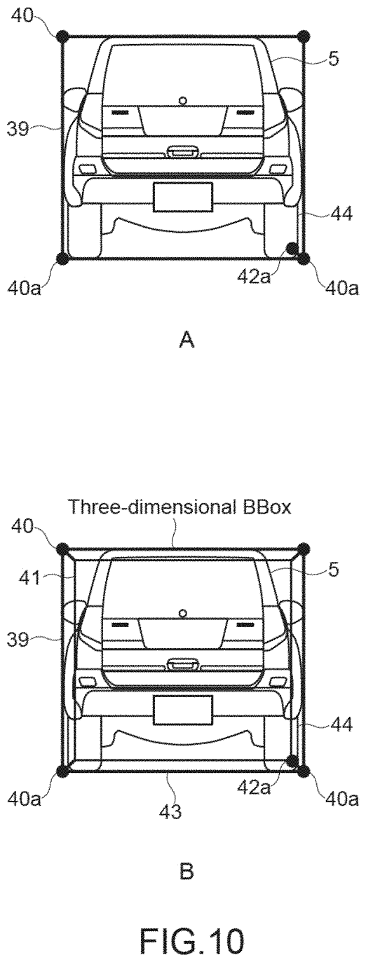

In the example shown in FIG. 10, the rear side of the vehicle 5 is imaged from the front.

The user 1 labels the front surface rectangle 39 on the rear side of the vehicle 5. Both the lower left vertex and the lower right vertex as viewed from the user 1 are the lowermost vertex 40a of the front surface rectangle 39.

In this case, the user 1 selects one lowermost vertex 40a and inputs the position of the corresponding vertex 42a of the rear surface rectangle 41.

In the example shown in FIG. 10A, as viewed from the user 1, the lower right vertex is selected as the lowermost vertex 40a and the position of the corresponding vertex 42a that is the lower right vertex of the rear surface rectangle 41 is input as the position of the rear surface rectangle 41.

For example, on the basis of the grounding point of the rear right wheel 44 of the vehicle 5, the position of the corresponding vertex 42a of the rear surface rectangle 41 can be input.

In the present embodiment, when the four vertices 40 of the front surface rectangle 39 and one corresponding vertex 42a of the rear surface rectangle 41 are arranged as appropriate on the GUI for annotation 30, the user 1 selects the label interpolation button 35. Due to the selection of the label interpolation button 35, the front surface rectangle 39 and the position of the rear surface rectangle 41 are input to the information processing apparatus 20. As a matter of course, the present technology is not limited to such an input method.

Referring back to FIG. 6, the label generation unit 23 of the information processing apparatus 20 generates the rear surface rectangle 41 (Step 203). Specifically, the coordinates of the pixels of the four vertices including the corresponding vertex 42a of the rear surface rectangle 41 input from the user 1 are calculated as shown in each B of FIGS. 7 to 10.

The rear surface rectangle 41 is generated on the basis of the front surface rectangle 39 and the position of the rear surface rectangle 41 input by the user 1.

Here, the height of the front surface rectangle 39 will be referred to as a height Ha and the width of the front surface rectangle 39 will be referred to as a width Wa.

In the present embodiment, a distance X1 to the lowermost vertex 40a of the front surface rectangle 39 from the vehicle-mounted camera is calculated. Moreover, the position of the rear surface rectangle 41, i.e., a distance X2 to the corresponding vertex 42a of the rear surface rectangle 41 connected to the lowermost vertex 40a of the front surface rectangle 39 from the vehicle-mounted camera are calculated.

Then, the rear surface rectangle 41 is generated by reducing the size of the front surface rectangle 39 using the distance X1 and the distance X2.

Specifically, a height Hb of the rear surface rectangle 41 and a width Wb of the rear surface rectangle 41 are calculated in accordance with the following expression.

Height Hb=height Ha×(distance X1/distance X2)

Width Wb=width Wa×(distance X1/distance X2)

A rectangular region having the calculated height Hb and width Wb is adjusted to the position of the corresponding vertex 42a of the rear surface rectangle 41 input from the user 1 and a rear surface rectangle 41 is generated. That is, on the basis of the position of the corresponding vertex 42a of the rear surface rectangle 41 input from the user 1, the rear surface rectangle is interpolated geometrically.

It should be noted that the distance X1 and the distance X2 are distances in a direction of an imaging optical axis of the vehicle-mounted camera. For example, a plane orthogonal to the imaging optical axis at a point spaced by 5 m on the imaging optical axis is assumed. In the captured image, distances to respective positions on the assumed plane from the vehicle-mounted camera are all 5 m.

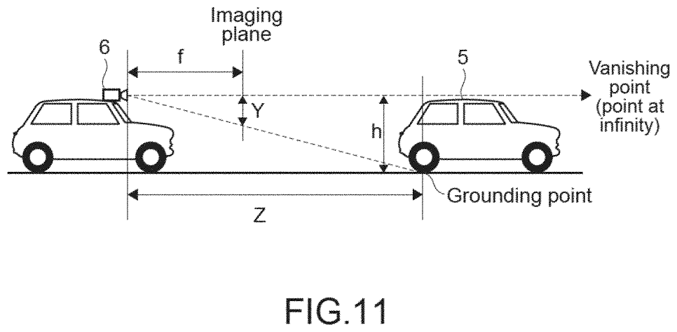

FIG. 11 is a schematic diagram for describing an example of a calculation method for the distance to the lowermost vertex 40a of the front surface rectangle 39 and the distance to the corresponding vertex 42a of the rear surface rectangle 41.

For example, a case where a distance Z to the vehicle 5 running forward in the front is calculated will be taken into consideration. It should be noted that with respect to the captured image, the horizontal direction is defined as an x axis direction and the vertical direction is defined as a y axis direction.

The coordinates of the pixel corresponding to a vanishing point in the captured image is calculated.

The coordinates of the pixel corresponding to the grounding point on a rearmost side of the forward vehicle 5 (the front side as viewed from a vehicle-mounted camera 6) are calculated.

In the captured image, the number of pixels from the vanishing point to the grounding point of the forward vehicle 5 is counted. That is, a difference Δy between a y coordinate of the vanishing point and a y coordinate of the grounding point is calculated.

The calculated difference Δy is multiplied by a pixel pitch of an imaging element of the vehicle-mounted camera 6 to calculate a distance Y from the position of the vanishing point on the imaging element to the grounding point of the forward vehicle 5.

An installation height h of the vehicle-mounted camera 6 shown in FIG. 11 and a focal distance f of the vehicle-mounted camera can be acquired as known parameters. Using those parameters, the distance Z to the forward vehicle 5 can be calculated in accordance with the following expression.

Z=(f×h)/Y

The distance X1 to the lowermost vertex 40a of the front surface rectangle 39 can also be calculated by using the difference Δy between the y coordinate of the vanishing point and the y coordinate of the lowermost vertex 40a in a similar way.

The distance to the corresponding vertex 42a of the rear surface rectangle 41 X2 can also be calculated by using the difference Δy between the y coordinate of the vanishing point and the y coordinate of the corresponding vertex 42a in a similar way.

Thus, in the present embodiment, the three-dimensional BBox is calculated on the basis of information about the vanishing point in the image for learning 27 and imaging information (pixel pitch, focal distance) regarding imaging of the image for learning 27.

As a matter of course, the present technology is not limited to a case where such a calculation method is used. The distance X1 to the lowermost vertex 40a of the front surface rectangle 39 and the distance X2 to the corresponding vertex 42a of the rear surface rectangle 41 may be calculated by another method.

For example, depth information (distance information) and the like obtained from a depth sensor mounted on the vehicle may be used.

As shown in each B of FIGS. 7 to 10, on the basis of the front surface rectangle 39 input from the user 1 and the rear surface rectangle 41 generated by the label generation unit 23, the three-dimensional BBox is generated (Step 204).

Thus, in the present embodiment, the three-dimensional BBox is generated as the label by interpolating the rear surface rectangle 41 on the basis of the front surface rectangle 39 and the position of the rear surface rectangle 41 input by the user 1.

The GUI output unit 22 updates and outputs the GUI for annotation 30 (Step 205). Specifically, the three-dimensional BBox generated in Step 204 is displayed superimposed in the image for learning 27 in the GUI for annotation 30.

The user 1 can adjust the displayed three-dimensional BBox. For example, eight vertices that define the three-dimensional BBox are adjusted as appropriate. Alternatively, vertices that can be adjusted may be only the four vertices 40 of the front surface rectangle 39, which can be input in Steps 201 and 202, and the single corresponding vertex 42a of the rear surface rectangle 41.

The user 1 selects the label determination button 36 in a case where the generation of the three-dimensional BBox has been completed. Accordingly, the three-dimensional BBox is determined with respect to the single vehicle 5 (Step 206).

It should be noted that information regarding the front surface rectangle 39 and the position of the rear surface rectangle 41 (e.g., the coordinates of the pixels of the vertices or the like) is displayed as input information in real time in the label information display portion 33 of the GUI for annotation 30 while the input operation of the front surface rectangle 39 and the position of the rear surface rectangle 41 is performed.

Moreover, information about the rear surface rectangle 41 generated by interpolation (e.g., the coordinates of the pixels of the vertices or the like) is selected as interpolation information in real time.

In a case where the generation of the three-dimensional BBox has been completed with respect to all vehicles 5, the save button 37 in the GUI for annotation 30 is selected. Accordingly, the three-dimensional BBox generated with respect to all the vehicles 5 is saved, and the annotation with respect to the image for learning 27 is completed.

Hereinafter, in the information processing apparatus 20 according to the present embodiment, a three-dimensional region that is a target object is generated as a label on the basis of the input information input from the user 1. Accordingly, the annotation accuracy can be improved.

It is assumed that a plurality of users 1 sets 3D annotation for object recognition such as three-dimensional BBoxes to the vehicles 5 with respect to image data. In this case, regarding the rear surface rectangles 41 that the users 1 cannot visually check, a large deviation can be caused by individual differences and the accuracy of the labels can lower.

In the object recognition based on the machine learning, the quality of the training data is important and lowering of the accuracy of the labels can lower the recognition accuracy of the object recognition.

In the automatic annotation by interpolation according to the present embodiment, the front surface rectangle 39 on the front side that can be visually checked and the position of the rear surface rectangle 41 based on the grounding direction line 46 are input. Then, the rear surface rectangle 41 is interpolated on the basis of such input information to generate the three-dimensional BBox.

Such automatic interpolation with the tool can sufficiently reduce a deviation caused by individual differences when a plurality of persons performs annotation work. Moreover, the efficiency of the annotation work can be enhanced. As a result, the accuracy of the labels can be improved, and the recognition accuracy of the object recognition can be improved.

Moreover, the automatic annotation by interpolation according to the present embodiment can be performed with a low processing load.

### Other Embodiments

The present technology is not limited to the above-mentioned embodiments, and various other embodiments can be realized.

The vehicle type information of the vehicle 5 may be used for interpolation of the rear surface rectangle 41 based on the input information.

For example, for each class of the classification by model such as a “small-sized vehicle”, a “large-sized vehicle”, a “van”, a “truck”, and a “bus”, information about a height of the vehicle 5, a length (size in front-rear direction), and a width (size in horizontal direction) is set as the vehicle type information in advance.

The user 1 operates the vehicle type selection button 34 in the GUI for annotation 30 and sets a vehicle type for each vehicle 5 of the image for learning 27.

The label generation unit 23 of the information processing apparatus 20 calculates a reduction rate of the front surface rectangle 39 on the basis of, for example, the front surface rectangle 39 and the position of the rear surface rectangle 41, which are input by the user 1, and the size of the set vehicle type. The front surface rectangle 39 is reduced at the calculated reduction rate, the rear surface rectangle 41 is generated, and the three-dimensional BBox is generated.

Such an interpolation method can also be employed.

As a matter of course, the rear surface rectangle 41 may be interpolated using both the vehicle type information and the distance X1 to the lowermost vertex 40a of the front surface rectangle 39 and the distance X2 to the corresponding vertex 42a of the rear surface rectangle 41.

In a case where the vehicle 5 is positioned on an oblique surface such as a slope way, the distance X1 to the lowermost vertex 40a of the front surface rectangle 39 and the distance X2 to the corresponding vertex 42a of the rear surface rectangle 41 are calculated after the gradient of the oblique surface is estimated for example. Accordingly, the rear surface rectangle 41 can be generated in accordance with an expression using (distance X1/distance X2) described above.

In the present disclosure, the vehicle is not limited to the automobile, and also includes a bicycle, a two-wheel motor vehicle (motor cycle), and the like. For example, in a case where the two-wheel motor vehicle is a target object, a three-dimensional BBox may be generated by defining the handle length as the width. As a matter of course, the present technology is not limited thereto.

Moreover, the target objects to which the present technology can be applied are not limited to the vehicles. Using living things such as humans, animals, fishes, and the like, mobile objects such as robots, drones, and watercraft, or any other objects as target objects, the present technology can be applied.

Moreover, the application of the present technology is not limited to the generation of the training data for building the machine learning model. That is, the present technology is not limited to the case where the training label is applied to the image for learning as the label.

The present technology can be applied to any annotation to apply a label (information) to an image that is a target object. By applying the present technology, the annotation accuracy can be improved.

Moreover, the present technology is also not limited to the case where the user inputs the information regarding the outer shape. A sensor device or the like may acquire the information regarding the outer shape and generate a label on the basis of the information regarding the outer shape.

[Vehicle Control System]

An application example of the machine learning model learned on the basis of the training data generated by the annotation system 50 according to the present technology will be described.

For example, the machine learning-based object recognition with the machine learning model can be applied to a vehicle control system that realizes an automated driving function capable of automated driving to a destination.

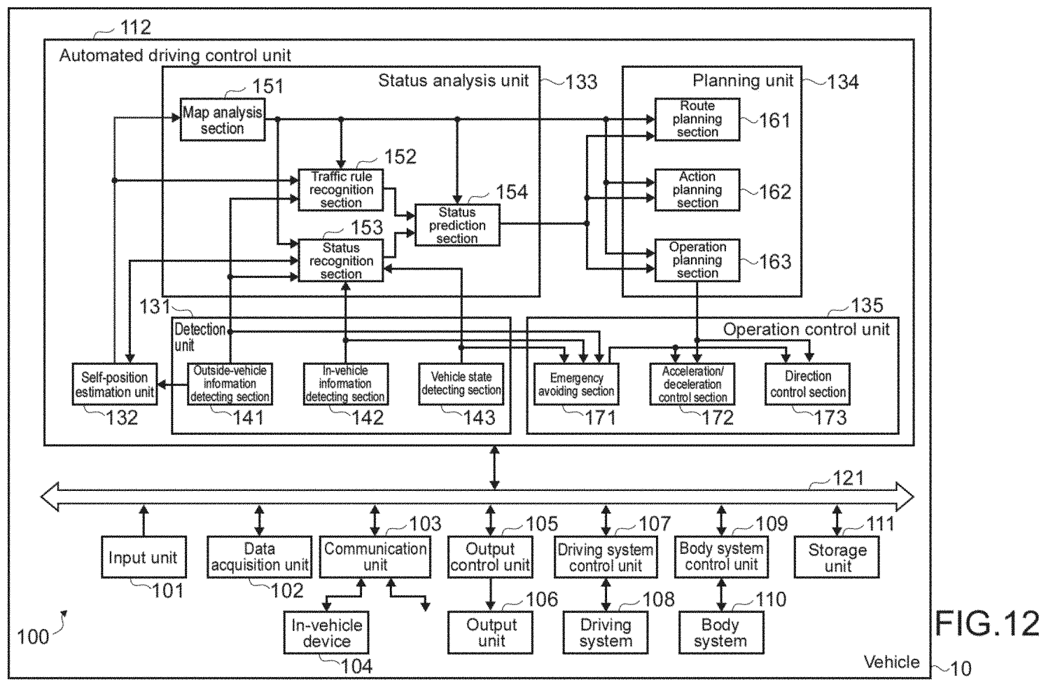

FIG. 12 is a block diagram showing a configuration example of the vehicle control system 100. The vehicle control system 100 is a system that is provided in the vehicle and performs various kinds of control on the vehicle.

The vehicle control system 100 includes an input unit 101, a data acquisition unit 102, a communication unit 103, an in-vehicle device 104, an output control unit 105, an output unit 106, a driving system control unit 107, a driving system 108, a body system control unit 109, a body system 110, a storage unit 111, and an automated driving control unit 112. The input unit 101, the data acquisition unit 102, the communication unit 103, the output control unit 105, the driving system control unit 107, the body system control unit 109, the storage unit 111, and the automated driving control unit 112 are mutually connected via a communication network 121. The communication network 121 is constituted by, for example, a vehicle-mounted communication network, a bus, and the like compatible with any standards such as a controller area network (CAN), a local interconnect network (LIN), a local area network (LAN), and FlexRay (registered trademark). It should be noted that the respective units of the vehicle control system 100 are directly connected without the communication network 121 in some cases.

It should be noted that hereinafter, in a case where the respective units of the vehicle control system 100 communicate with one another via the communication network 121, the description of the communication network 121 will be omitted. For example, in a case where the input unit 101 and the automated driving control unit 112 communicate with each other via the communication network 121, it will be simply expressed: the input unit 101 and the automated driving control unit 112 communicate with each other.

The input unit 101 includes a device used for an occupant to input various kinds of data, instructions, and the like. For example, the input unit 101 includes an operation device such as a touch panel, a button, a microphone, a switch, and a lever and an operation device and the like capable of inputting using a method other than a manual operation by a voice, a gesture, and the like. Moreover, for example, the input unit 101 may be a remote control device utilizing infrared rays or another radio waves, a mobile device adaptive to operation of the vehicle control system 100, or an external connection device such as a wearable device. The input unit 101 generates an input signal on the basis of data, an instruction, or the like input by the occupant and supplies to the input signal to the respective units of the vehicle control system 100.

The data acquisition unit 102 includes various kinds of sensors and the like that acquire data to be used for processing of the vehicle control system 100, and supplies to the acquired data to the respective units of the vehicle control system 100.

For example, the data acquisition unit 102 includes various kinds of sensors for detecting a state and the like of the vehicle. Specifically, for example, the data acquisition unit 102 includes a gyro sensor, an acceleration sensor, an inertial measurement unit (IMU), a sensor for detecting an amount of operation of an accelerator pedal, an amount of operation of a brake pedal, a steering angle of a steering wheel, engine r.p.m., motor r.p.m., or a rotational speed of the wheels, and the like.

Moreover, for example, the data acquisition unit 102 includes various kinds of sensors for detecting information about the outside of the vehicle. Specifically, for example, the data acquisition unit 102 includes an imaging device such as a time-of-flight (ToF) camera, a stereo camera, a monocular camera, an infrared camera, and other cameras. Moreover, for example, the data acquisition unit 102 includes an environmental sensor for detecting atmospheric conditions or weather conditions and a peripheral information detecting sensor for detecting objects on the periphery of the vehicle. The environmental sensor is constituted by, for example, a rain drop sensor, a fog sensor, a sunshine sensor, and a snow sensor, and the like. The peripheral information detecting sensor is constituted by, for example, an ultrasonic sensor, a radar device, and a LIDAR device (light detection and ranging device, or laser imaging detection and ranging device), a sound navigation and ranging device (SONAR device), and the like.

In addition, for example, the data acquisition unit 102 includes various kinds of sensors for detecting the current position of the vehicle. Specifically, for example, the data acquisition unit 102 includes a GNSS receiver that receives a satellite signal (hereinafter, referred to as GNSS signal) from a global navigation satellite system (GNSS) satellite that is a navigation satellite and the like.

Moreover, for example, the data acquisition unit 102 includes various kinds of sensors for detecting information about the inside of the vehicle. Specifically, for example, the data acquisition unit 102 includes an imaging device that images the driver, a biosensor that detects biological information of the driver, a microphone that collects sound within the interior of the vehicle, and the like. The biosensor is, for example, disposed in a seat surface, the steering wheel, or the like, and detects biological information of an occupant sitting in a seat or the driver holding the steering wheel.

The communication unit 103 communicates with the in-vehicle device 104, and various kinds of outside-vehicle devices, a server, a base station, and the like and sends data supplied from the respective units of the vehicle control system 100 or supplies the received data to the respective units of the vehicle control system 100. It should be noted that a communication protocol supported by the communication unit 103 is not particularly limited, and the communication unit 103 can also support a plurality of kinds of communication protocols.

For example, the communication unit 103 performs wireless communication with the in-vehicle device 104 using wireless LAN, Bluetooth (registered trademark), near field communication (NFC), wireless universal serial bus (WUSB), or the like. In addition, for example, the communication unit 103 performs wired communication with the in-vehicle device 104 by universal serial bus (USB), high-definition multimedia interface (HDMI (registered trademark)), mobile high-definition link (MHL), or the like via a connection terminal (and a cable if necessary) not depicted in the figures.

In addition, for example, the communication unit 103 communicates with a device (for example, an application server or a control server) present on an external network (for example, the Internet, a cloud network, or a company-specific network) via a base station or an access point. Moreover, for example, the communication unit 103 communicates with a terminal present in the vicinity of the vehicle (which terminal is, for example, a terminal of a pedestrian or a store, or a machine type communication (MTC) terminal) using a peer to peer (P2P) technology. In addition, for example, the communication unit 103 carries out V2X communication such as communication between a vehicle and a vehicle (Vehicle to Vehicle), communication between a road and a vehicle (Vehicle to Infrastructure), communication between the vehicle and a home (Vehicle to Home), and communication between a pedestrian and a vehicle (Vehicle to Pedestrian).

Moreover, for example, the communication unit 103 includes a beacon receiving section and receives a radio wave or an electromagnetic wave transmitted from a radio station installed on a road or the like, and thereby obtains information about the current position, congestion, a closed road, a necessary time, or the like.

The in-vehicle device 104 includes, for example, a mobile device and a wearable device possessed by an occupant, an information device carried into or attached to the vehicle, a navigation device that searches for a path to an arbitrary destination, and the like.

The output control unit 105 controls the output of various kinds of information to the occupant of the vehicle or the outside of the vehicle. For example, the output control unit 105 generates an output signal including at least one of visual information (e.g., image data) or auditory information (e.g., audio data) and supplies the output signal to the output unit 106, to thereby control the output of the visual information and the auditory information from the output unit 106. Specifically, for example, the output control unit 105 combines image data imaged by different imaging devices of the data acquisition unit 102 to generate a bird's-eye image, a panoramic image, or the like, and supplies an output signal including the generated image to the output unit 106. Moreover, for example, the output control unit 105 generates audio data including an alarm sound, an alarm message, or the like with respect to danger such as collision, contact, and entry in a dangerous zone and supplies to an output signal including the generated audio data to the output unit 106.

The output unit 106 includes a device capable of outputting visual information or auditory information to the occupant of the vehicle or the outside of the vehicle. For example, the output unit 106 includes a display device, an instrument panel, an audio speaker, headphones, a wearable device such as an eyeglass type display worn by an occupant, a projector, a lamp, or the like. The display device provided in the output unit 106 may, for example, be a device that displays visual information in the field of view of the driver such as a head-up display, a see-through display, or a device having an augmented reality (AR) display function other than a device having a normal display.

The driving system control unit 107 generates various kinds of control signals and supplies the various kinds of control signals to the driving system 108, to thereby control the driving system 108. Moreover, the driving system control unit 107 supplies the control signals to the respective units other than the driving system 108 in a manner that depends on needs and performs notification of the control state of the driving system 108 or the like.

The driving system 108 includes various kinds of devices related to the driving system of the vehicle. For example, the driving system 108 includes a driving force generating device for generating driving force, such as an internal combustion engine, a driving motor, or the like, a driving force transmitting mechanism for transmitting driving force to the wheels, a steering mechanism for adjusting the steering angle, a braking device for generating braking force, an antilock brake system (ABS), electronic stability control (ESC), an electric power steering device, and the like.

The body system control unit 109 generates various kinds of control signals and supplies the various kinds of control signals to the body system 110, to thereby control the body system 110. Moreover, the body system control unit 109 supplies the control signals to the respective units other than the body system 110 in a manner that depends on needs, and performs notification of the control state of the body system 110 or the like.

The body system 110 includes various kinds of devices provided to the vehicle body. For example, the body system 110 includes a keyless entry system, a smart key system, a power window device, or various kinds of lamps (e.g., a headlamp, a backup lamp, a brake lamp, a turn signal, or a fog lamp), or the like.

The storage unit 111 includes, for example, a read only memory (ROM), a random access memory (RAM), a magnetic storage device such as a hard disc drive (HDD) or the like, a semiconductor storage device, an optical storage device, a magneto-optical storage device, and the like. The storage unit 111 stores various kinds of programs, various kinds of data, and the like used by the respective units of the vehicle control system 100. For example, the storage unit 111 stores map data of a three-dimensional high-precision map such as a dynamic map, a global map that covers a wide area at precision lower than that of a high-precision map, and a local map including information about the surroundings of the vehicle, and the like.

The automated driving control unit 112 performs control regarding automated driving such as autonomous driving or driving assistance. Specifically, for example, the automated driving control unit 112 may perform cooperative control intended to implement functions of an advanced driver assistance system (ADAS) including collision avoidance or shock mitigation for the vehicle, following driving based on a following distance, vehicle speed maintaining driving, a warning of collision of the vehicle, a warning of deviation of the vehicle from a lane, and the like. Moreover, for example, the automated driving control unit 112 performs cooperative control intended for automated driving, which makes the vehicle to travel automatedly without depending on the operation of the driver, or the like. The automated driving control unit 112 includes a detection unit 131, a self-position estimation unit 132, a status analysis unit 133, a planning unit 134, and an operation control unit 135.

The automated driving control unit 112 includes, for example, hardware required for a computer, such as a CPU, a RAM, and a ROM. The CPU loads a program recorded on the ROM in advance to the RAM and execute the program, and various kinds of information processing methods are thus performed.

A specific configuration of the automated driving control unit 112 is not limited and, for example, a programmable logic device (PLD) such as a field programmable gate array (FPGA) or another device such as an application specific integrated circuit (ASIC) may be used.

As shown in FIG. 12, the automated driving control unit 112 includes the detection unit 131, the self-position estimation unit 132, the status analysis unit 133, the planning unit 134, and the operation control unit 135. For example, the CPU of the automated driving control unit 112 executes the predetermined program to thereby configure the respective functional blocks.

The detection unit 131 detects various kinds of information required for controlling automated driving. The detection unit 131 includes an outside-vehicle information detecting section 141, an in-vehicle information detecting section 142, and a vehicle state detecting section 143.

The outside-vehicle information detecting section 141 performs detection processing of information about the outside of the vehicle on the basis of data or signals from the respective units of the vehicle control system 100. For example, the outside-vehicle information detecting section 141 performs detection processing of an object on the periphery of the vehicle, recognition processing, and tracking processing, and detection processing of a distance to an object. An object that is a detection target includes, for example, a vehicle, a human, an obstacle, a structure, a road, a traffic light, a traffic sign, a road sign, and the like. Moreover, for example, the outside-vehicle information detecting section 141 performs detection processing of an environment surrounding the vehicle. The surrounding environment that is the detection target includes, for example, weather, temperature, humidity, brightness, and a condition on a road surface, and the like. The outside-vehicle information detecting section 141 supplies data indicating a result of the detection processing to the self-position estimation unit 132, a map analysis section 151, a traffic rule recognition section 152, and a status recognition section 153 of the status analysis unit 133, an emergency avoiding section 171 of the operation control unit 135, and the like.

For example, a machine learning model is built learned on the basis of the training data generated by the annotation system 50 according to the present technology in the outside-vehicle information detecting section 141. Then, machine learning-based recognition processing for the vehicle 5 is performed.

The in-vehicle information detecting section 142 performs detection processing of information about the inside of the vehicle on the basis of data or signals from the respective units of the vehicle control system 100. For example, the in-vehicle information detecting section 142 performs authentication processing and recognition processing of the driver, detection processing of the state of the driver, detection processing of the occupant, and detection processing of an environment inside the vehicle, and the like. The state of the driver that is the detection target includes, for example, a physical condition, vigilance, a degree of concentration, a degree of fatigue, a gaze direction, and the like. The environment inside the vehicle that is the detection target includes, for example, temperature, humidity, brightness, odor, and the like. The in-vehicle information detecting section 142 supplies data indicating a result of the detection processing to the status recognition section 153 of the status analysis unit 133, the emergency avoiding section 171 of the operation control unit 135, and the like.

The vehicle state detecting section 143 performs detection processing of the state of the vehicle on the basis of data or signals from the respective units of the vehicle control system 100. The state of the vehicle that is the detection target includes, for example, a speed, acceleration, a steering angle, the presence/absence and contents of an abnormality, a state of a driving operation, position and tilt of the power seat, a door lock state, a state of another vehicle-mounted device, and the like. The vehicle state detecting section 143 supplies data indicating a result of the detection processing to the status recognition section 153 of the status analysis unit 133, the emergency avoiding section 171 of the operation control unit 135, and the like.

Based on data or signals from the respective units of the vehicle control system 100, such as the outside-vehicle information detecting section 141 and the status recognition section 153 of the status analysis unit 133, the self-position estimation unit 132 performs estimation processing of the position and the attitude and the like of the vehicle. Moreover, the self-position estimation unit 132 generates a local map (hereinafter, referred to as map for self-position estimation) used for estimating the self-position in a manner that depends on needs. The map for self-position estimation is, for example, a high-precision map using a technology such as simultaneous localization and mapping (SLAM). The self-position estimation unit 132 supplies data indicating a result of the estimation processing to the map analysis section 151, the traffic rule recognition section 152, and the status recognition section 153 of the status analysis unit 133, and the like. Moreover, the self-position estimation unit 132 causes the storage unit 111 to store the map for self-position estimation.

Hereinafter, the estimation processing of the position and the attitude and the like of the vehicle will be sometimes referred to as self-position estimation processing. Moreover, the information about the position and the attitude of the vehicle will be referred to as position and attitude information. Therefore, the self-position estimation processing performed by the self-position estimation unit 132 is processing of estimating the position and attitude information of the vehicle.

The status analysis unit 133 performs analysis processing of the vehicle and the surrounding status. The status analysis unit 133 includes the map analysis section 151, the traffic rule recognition section 152, the status recognition section 153, and a status prediction section 154.

The map analysis section 151 performs analysis processing of various kinds of maps stored in the storage unit 111 and builds a map including information required for processing of automated driving while using data or signals from the respective units of the vehicle control system 100, such as the self-position estimation unit 132 and the outside-vehicle information detecting section 141, in a manner that depends on needs. The map analysis section 151 supplies the built map to the traffic rule recognition section 152, the status recognition section 153, the status prediction section 154, a route planning section 161, an action planning section 162, and an operation planning section 163 of the planning unit 134, and the like.

Based on data or signals from the respective units of the vehicle control system 100, such as the self-position estimation unit 132, the outside-vehicle information detecting section 141, and the map analysis section 151, the traffic rule recognition section 152 performs recognition processing of the traffic rules on the periphery of the vehicle. With this recognition processing, for example, positions and states of signals on the periphery of the vehicle, the contents of traffic regulation of the periphery of the vehicle, and a lane where driving is possible, and the like are recognized. The traffic rule recognition section 152 supplies data indicating a result of the recognition processing to the status prediction section 154 and the like.

Based on data or signals from the respective units of the vehicle control system 100, such as the self-position estimation unit 132, the outside-vehicle information detecting section 141, the in-vehicle information detecting section 142, the vehicle state detecting section 143, and the map analysis section 151, the status recognition section 153 performs recognition processing of a status regarding the vehicle. For example, the status recognition section 153 performs recognition processing of the status of the vehicle, the status of the periphery of the vehicle, and the status of the driver of the vehicle, and the like. Moreover, the status recognition section 153 generates a local map (hereinafter, referred to as map for status recognition) used for recognition of the status of the periphery of the vehicle in a manner that depends on needs. The map for status recognition is, for example, a occupancy grid map.

The status of the vehicle that is the recognition target includes, for example, the position, attitude, and movement (e.g., the speed, acceleration, the movement direction, and the like) of the vehicle, and the presence/absence and the contents of an abnormality, and the like. The status of the periphery of the vehicle that is the recognition target includes, for example, the kind and the position of surrounding stationary object, kinds, positions and movements of surrounding moving objects (e.g., the speed, acceleration, the movement direction, and the like), a configuration of a surrounding road and a state of the road surface, and the weather, the temperature, the humidity, and brightness of the periphery, and the like. The state of the driver that is the recognition target includes, for example, a physical condition, vigilance, a degree of concentration, a degree of fatigue, movement of the line of sight, and a driving operation, and the like.

The status recognition section 153 supplies data indicating a result of the recognition processing (including the map for status recognition as necessary) to the self-position estimation unit 132, the status prediction section 154, and the like. Moreover, the status recognition section 153 causes the storage unit 111 to store the map for status recognition.

Based on data or signals from the respective units of the vehicle control system 100, such as the map analysis section 151, the traffic rule recognition section 152, and the status recognition section 153, the status prediction section 154 performs prediction processing of a status regarding the vehicle. For example, the status prediction section 154 performs prediction processing of the status of the vehicle, the status of the periphery of the vehicle, and the status of the driver, and the like.

The status of the vehicle that is a prediction target includes, for example, behaviors of the vehicle, the occurrence of an abnormality, and a distance to empty, and the like. The status of the periphery of the vehicle that is the prediction target includes, for example, behaviors of a moving object on the periphery of the vehicle, a change in a state of a signal, and a change in an environment such as weather, and the like. The status of the driver that is the prediction target includes, for example, behaviors and a physical condition of the driver and the like.

The status prediction section 154 supplies data indicating a result of the prediction processing to the route planning section 161, the action planning section 162, and the operation planning section 163 of the planning unit 134, and the like together with data from the traffic rule recognition section 152 and the status recognition section 153.

Based on data or signals from the respective units of the vehicle control system 100, such as the map analysis section 151 and the status prediction section 154, the route planning section 161 plans a route to a destination. For example, on the basis of a global map, the route planning section 161 sets a target path that is a route from the current position to a specified destination. Moreover, for example, the route planning section 161 changes the route as appropriate on the basis of a status such as congestion, an accident, traffic regulation, and construction work, and a physical condition of the driver, or the like. The route planning section 161 supplies data indicating the planned route to the action planning section 162 and the like.

Based on data or signals from the respective units of the vehicle control system 100, such as the map analysis section 151 and the status prediction section 154, the action planning section 162 plans an action of the vehicle for safely driving on a route planned by the route planning section 161 in a planned time. For example, the action planning section 162 performs planning start, stop, a driving direction (e.g., going forward, going rearward, a left turn, a right turn, a direction change, or the like), a driving lane, a driving speed, and overtaking, and the like. The action planning section 162 supplies data indicating the planned action of the vehicle to the operation planning section 163 and the like.

Based on data or signals from the respective units of the vehicle control system 100, such as the map analysis section 151 and the status prediction section 154, the operation planning section 163 plans an operation of the vehicle for realizing the action planned by the action planning section 162. For example, the operation planning section 163 plans acceleration, deceleration, a driving trajectory, and the like. The operation planning section 163 supplies data indicating the planned operation of the vehicle to the acceleration/deceleration control section 172 and the direction control section 173 of the operation control unit 135 and the like.

The operation control unit 135 controls the operation of the vehicle. The operation control unit 135 includes the emergency avoiding section 171, an acceleration/deceleration control section 172, and a direction control section 173.

Based on detection results of the outside-vehicle information detecting section 141, the in-vehicle information detecting section 142, and the vehicle state detecting section 143, the emergency avoiding section 171 performs detection processing of an emergency such as collision, contact, entry in a dangerous zone, an abnormality of the driver, and an abnormality of the vehicle. In a case where the emergency avoiding section 171 has detected the occurrence of the emergency, the emergency avoiding section 171 plans an operation of the vehicle for avoiding an emergency such as sudden stop and sudden turn. The emergency avoiding section 171 supplies data indicating the planned operation of the vehicle to the acceleration/deceleration control section 172, and the direction control section 173, and the like.

The acceleration/deceleration control section 172 performs acceleration/deceleration control for realizing the operation of the vehicle, which has been planned by the operation planning section 163 or the emergency avoiding section 171. For example, the acceleration/deceleration control section 172 calculates a control target value for the driving force generating device or the braking device for realizing the planned acceleration, deceleration, or sudden stop and supplies a control command indicating the calculated control target value to the driving system control unit 107.

The direction control section 173 performs direction control for realizing the operation of the vehicle, which has been planned by the operation planning section 163 or the emergency avoiding section 171. For example, the direction control section 173 calculates a control target value for a steering mechanism for realizing a driving trajectory or sudden turn planned by the operation planning section 163 or the emergency avoiding section 171 and supplies a control command indicating the calculated control target value to the driving system control unit 107.

FIG. 13 is a block diagram showing a hardware configuration example of the information processing apparatus 20.

The information processing apparatus 20 includes a CPU 61, a ROM (read only memory) 62, a RAM 63, an input/output interface 65, and a bus 64 that connects them to one another. A display unit 66, an input unit 67, a storage unit 68, a communication unit 69, and a drive unit 70, and the like are connected to the input/output interface 65.

The display unit 66 is, for example, a display device using liquid-crystal, EL, or the like. The input unit 67 is, for example, a keyboard, a pointing device, a touch panel, or another operation device. In a case where the input unit 67 includes a touch panel, the touch panel can be integral with the display unit 66.

The storage unit 68 is a nonvolatile storage device and is, for example, an HDD, a flash memory, or another solid-state memory. The drive unit 70 is, for example, a device capable of driving a removable recording medium 71 such as an optical recording medium and a magnetic record tape.

The communication unit 69 is a modem, a router, or another communication device for communicating with the other devices, which are connectable to a LAN, WAN or the like. The communication unit 69 may perform wired communication or may perform wireless communication. The communication unit 69 is often used separately from the information processing apparatus 20.

The information processing by the information processing apparatus 20 having the hardware configuration as described above is realized by cooperation of software stored in the storage unit 68, the ROM 62, or the like with hardware resources of the information processing apparatus 20. Specifically, by loading the program that configures the software to the RAM 63, which has been stored in the ROM 62 or the like, and executing the program, the information processing method according to the present technology is realized.

The program is, for example, installed in the information processing apparatus 20 via the recording medium 61. Alternatively, the program may be installed in the information processing apparatus 20 via a global network or the like. Otherwise, any computer-readable non-transitory storage medium may be used.

In the example shown in FIG. 1, the user terminal 10 and the information processing apparatus 20 are respectively configured by different computers. The user terminal 10 operated by the user 1 may have the function of the information processing apparatus 20. That is, the user terminal 10 and the information processing apparatus 20 may be configured integrally. In this case, the user terminal 10 itself is an information processing apparatus according to an embodiment of the present technology.

By cooperation of a plurality of computers mounted connected to communicate with one another via a network or the like, the information processing method and the program according to the present technology may be executed and the information processing apparatus according to the present technology may be configured.

That is, the information processing method and the program according to the present technology can be executed not only in a computer system configured by a single computer but also in a computer system in which a plurality of computer operates in cooperation.

It should be noted that in the present disclosure, the system means a group of a plurality of components (apparatuses, modules (components), and the like) and it does not matter whether or not all components is in the same casing. Therefore, a plurality of apparatuses housed in separate casings and connected via a network and a single apparatus in which a plurality of modules is housed in a single casing are both systems.

The execution of the information processing method and the program according to the present technology according to the present technology by the computer system includes, for example, both a case where the acquisition of the input information, the label interpolation, and the like are performed by a single computer and a case where the respective processes are performed by different computers. Moreover, execution of the respective processes by a predetermined computer includes causing another computer to performing some or all of the processes to acquire the results.

That is, the information processing method and the program according to the present technology can also be applied to a cloud computing configuration in which a single function is shared and cooperatively processed by a plurality of apparatuses via a network.

The respective configurations such as the annotation system, the user terminal, the information processing apparatus, the GUI for annotation and the like, the label interpolation flow, and the like, which have been described with reference to the respective drawings, are merely embodiments, and can be arbitrarily modified without departing from the gist of the present technology. That is, any other configuration, algorithm, and the like for carrying out the present technology may be employed.

In the present disclosure, in a case where the word “approximately” is used for describing a shape or the like, it is used merely for easy understanding of the description, and the use/non-use of the word “approximately” does not have a special meaning.

That is, in the present disclosure, it is assumed that the concepts that define the shape, the size, the position relationship, the state, and the like such as “center”, “middle”, “uniform”, “equal”, the “same”, “orthogonal”, “parallel”, “symmetric”, “extending”, “axial”, “columnar”, “cylindrical”, “ring-shaped”, and “annular” are concepts including “substantially center”, “substantially middle”, “substantially uniform”, “substantially equal”, “substantially the same”, “substantially orthogonal”, “substantially parallel”, “substantially symmetric”, “substantially extending”, “substantially axial”, “substantially columnar”, “substantially cylindrical”, “substantially ring-shaped”, “substantially annular”, and the like.

For example, states included in a predetermined range (e.g., ±10% range) using “completely center”, “completely middle”, “completely uniform”, “completely equal”, “completely the same”, “completely orthogonal”, “completely parallel”, “completely symmetric”, “completely extending”, “completely axial”, “completely columnar”, “completely cylindrical”, “completely ring-shaped”, “completely annular”, and the like as the basis are also included.

Therefore, also in a case where the term “approximately” is not added, they can include concepts expressed by adding so-called “approximately”. In contrast, states expressed with “approximately” should not be understood to exclude complete states.

In the present disclosure, an expression with “than”, e.g., “larger than A” or “smaller than A”, is an expression comprehensively including both of a concept including a case where it is equivalent to A and a concept not including a case where it is equivalent to A. For example, “larger than A” is not limited to a case where it is equivalent to A, and also includes “equal to or larger than A”. Moreover, “smaller than A” is not limited to “smaller than A”, and also includes “equal to or smaller than A”.

When carrying out the present technology, it is sufficient to employ specific settings and the like as appropriate from the concepts included in “larger than A” and “smaller than A” so as to provide the above-mentioned effects.

At least two feature parts of the feature parts of the present technology described above can also be combined. That is, various feature parts described in each of the above-mentioned embodiments may be arbitrarily combined across those embodiments. Moreover, various effects described above are merely exemplary and not limitative and also other effects may be provided.

It should be noted that the present technology can also take the following configurations.

(1) An information processing apparatus, including

a generation unit that generates, with respect to a target object in an image on the basis of information regarding an outer shape of the target object, a three-dimensional region surrounding the target object as a label, in which

the information regarding the outer shape is a part of the label, and

the generation unit interpolates, on the basis of a part of the label, another part of the label to thereby generate the label.

(2) The information processing apparatus according to (1), in which

the image is an image for learning, and

the generation unit generates the label on the basis of the information regarding the outer shape, which is input from the user.

(3) The information processing apparatus according to (1) or (2), further including

a GUI output unit that outputs a graphical user interface (GUI) for inputting the input information regarding the outer shape of the target object with respect to the image for learning.

(4) The information processing apparatus according to any one of (1) to (3), in which

the label is a three-dimensional bounding box.

(5) The information processing apparatus according to any one of (1) to (4), in which

the label is a three-dimensional bounding box,

the input information regarding the outer shape includes a first rectangular region positioned on a front side of the target object and a position of a second rectangular region that is opposite to the first rectangular region and positioned on a deep side of the target object, and

the generation unit interpolates, on the basis of the first rectangular the region and the position of the second rectangular region, the second rectangular region to thereby generate the three-dimensional bounding box.

(6) The information processing apparatus according to (5), in which

the position of the second rectangular region is a position of a vertex of the second rectangular region, which is connected to a vertex positioned at a lowermost position of the first rectangular region.

(7) The information processing apparatus according to (5) or (6), in which

the position of the second rectangular region is a position on a deepest side of the target object on a line extending to a deep side on a surface on which the target object is disposed from a vertex positioned at a lowermost position of the first rectangular region.

(8) The information processing apparatus according to any one of (5) to (7), in which

the target object is a vehicle, and

the position of the second rectangular region is a position on a deepest side of the target object on a line that extends from a vertex positioned at a lowermost position of the first rectangular region and is parallel to a line connecting grounding points of a plurality of wheels arranged in a direction in which the first rectangular region and the second rectangular region are opposite to each other.

(9) The information processing apparatus according to (8), in which

the vertex positioned at the lowermost position of the first rectangular region is positioned on the line connecting the grounding points of the plurality of wheels arranged in the direction in which the first rectangular region and the second rectangular region are opposite to each other.

(10) The information processing apparatus according to any one of (1) to (9), in which

the generation unit generates the label on the basis of vehicle type information regarding the vehicle.

(11) The information processing apparatus according to any one of (1) to (10), in which

the image for learning is an image captured by an imaging device, and

the generation unit generates the label on the basis of imaging information regarding imaging of the image for learning.

(12) The information processing apparatus according to any one of (1) to (11), in which

the generation unit generates the label on the basis of information about a vanishing point in the image for learning.

(13) The information processing apparatus according to any one of (1) to (12), in which

the target object is a vehicle.

(14) The information processing apparatus according to any one of (1) to (13), in which

the image for learning is a two-dimensional image.

(15) An information processing method to be executed by a computer system, including

a generation step of generating, with respect to a target object in an image on the basis of information regarding an outer shape of the target object, a three-dimensional region surrounding the target object as a label, in which

the information regarding the outer shape is a part of the label, and

the generation step is interpolating, on the basis of a part of the label, another part of the label to thereby generate the label.

(16) A program that causes a computer system to execute an information processing method including

a generation step of generating, with respect to a target object in an image on the basis of information regarding an outer shape of the target object, a three-dimensional region surrounding the target object as a label, in which

the information regarding the outer shape is a part of the label, and

the generation step is interpolating, on the basis of a part of the label, another part of the label to thereby generate the label.

### REFERENCE SIGNS LIST

1 user
5 vehicle
6 vehicle-mounted camera
10 user terminal
20 information processing apparatus
27 image for learning
30 GUI for annotation
39 front surface rectangle
40a lowermost vertex of front surface rectangle
41 rear surface rectangle
42a corresponding vertex of rear surface rectangle
46 grounding direction line
50 annotation system
100 vehicle control system

1. An information processing apparatus, comprising
a generation unit that generates, with respect to a target object in an image on a basis of information regarding an outer shape of the target object, a three-dimensional region surrounding the target object as a label, wherein
the information regarding the outer shape is a part of the label, and
the generation unit interpolates, on a basis of a part of the label, another part of the label to thereby generate the label.

2. The information processing apparatus according to claim 1, wherein
the image is an image for learning, and
the generation unit generates the label on a basis of the information regarding the outer shape, which is input from the user.

3. The information processing apparatus according to claim 1, further comprising
a GUI output unit that outputs a graphical user interface (GUI) for inputting the information regarding the outer shape of the target object with respect to the image for learning.

4. The information processing apparatus according to claim 1, wherein
the label is a three-dimensional bounding box.

5. The information processing apparatus according to claim 1, wherein
the label is a three-dimensional bounding box,
the information regarding the outer shape includes a first rectangular region positioned on a front side of the target object and a position of a second rectangular region that is opposite to the first rectangular region and positioned on a deep side of the target object, and
the generation unit interpolates, on a basis of the first rectangular the region and the position of the second rectangular region, the second rectangular region to thereby generate the three-dimensional bounding box.

6. The information processing apparatus according to claim 5, wherein
the position of the second rectangular region is a position of a vertex of the second rectangular region, which is connected to a vertex positioned at a lowermost position of the first rectangular region.

7. The information processing apparatus according to claim 5, wherein
the position of the second rectangular region is a position on a deepest side of the target object on a line extending to a deep side on a surface on which the target object is disposed from a vertex positioned at a lowermost position of the first rectangular region.

8. The information processing apparatus according to claim 5, wherein
the target object is a vehicle, and
the position of the second rectangular region is a position on a deepest side of the target object on a line that extends from a vertex positioned at a lowermost position of the first rectangular region and is parallel to a line connecting grounding points of a plurality of wheels arranged in a direction in which the first rectangular region and the second rectangular region are opposite to each other.

9. The information processing apparatus according to claim 8, wherein
the vertex positioned at the lowermost position of the first rectangular region is positioned on the line connecting the grounding points of the plurality of wheels arranged in the direction in which the first rectangular region and the second rectangular region are opposite to each other.

10. The information processing apparatus according to claim 1, wherein
the generation unit generates the label on a basis of vehicle type information regarding the vehicle.

11. The information processing apparatus according to claim 1, wherein
the image for learning is an image captured by an imaging device, and
the generation unit generates the label on a basis of imaging information regarding imaging of the image for learning.

12. The information processing apparatus according to claim 1, wherein
the generation unit generates the label on a basis of information about a vanishing point in the image for learning.

13. The information processing apparatus according to claim 1, wherein
the target object is a vehicle.

14. The information processing apparatus according to claim 1, wherein
the image for learning is a two-dimensional image.

15. An information processing method to be executed by a computer system, comprising
a generation step of generating, with respect to a target object in an image on a basis of information regarding an outer shape of the target object, a three-dimensional region surrounding the target object as a label, wherein
the information regarding the outer shape is a part of the label, and
the generation step is interpolating, on a basis of a part of the label, another part of the label to thereby generate the label.

16. A program that causes a computer system to execute an information processing method comprising
a generation step of generating, with respect to a target object in an image on a basis of information regarding an outer shape of the target object, a three-dimensional region surrounding the target object as a label, wherein
the information regarding the outer shape is a part of the label, and
the generation step is interpolating, on a basis of a part of the label, another part of the label to thereby generate the label.
